(19) United States
(12) Patent Application Publication
(10) Pub. No.: US 2021/0029783 A1
(43) Pub. Date: Jan. 28, 2021

(54) RADIANT HEATING DEVICE AND HOB COMPRISING A RADIANT HEATING DEVICE OF THIS KIND

(71) Applicant: E.G.O. Elektro-Geraetebau GmbH, Oberderdingen (DE)

(72) Inventors: Mathias Bellm, Ubstadt-Weiher (DE); Volker Block, Bretten (DE); Marcus Frank, Sulzfeld (DE); Marius Gesell, Eppingen (DE); Gerd Krueger, Bretten (DE); Matthias Mangler, Karlsbad (DE); Jochen Rickert, Oberderdingen (DE); Annika Wagner, Niefern Oeschelbronn (DE)

(21) Appl. No.: 16/929,325

(22) Filed: Jul. 15, 2020

(30) Foreign Application Priority Data
Jul. 25, 2019 (DE) 10 2019 211 101.7

(51) Int. Cl. H05B 3/76; H05B 3/74

(52) U.S. Cl. CPC H05B 3/76; H05B 2213/07; H05B 3/746

(57) ABSTRACT

A radiant heating device for a hob has a sheet-like carrier with a carrier surface on its top side on which an electrical heating element runs in a meandering manner within an outer edge. A single temperature sensor is arranged in a temperature sensor housing which is arranged above a region which is free of heating elements. The temperature sensor housing covers the temperature sensor at the top and to the side and encloses the said temperature sensor in all directions. The temperature sensor housing is designed so as to be electrically insulating and thermally insulating at least at the top and to the side, wherein the said temperature sensor housing consists of an inner electrically insulating insulation housing part with the temperature sensor therein and an outer surrounding thermally insulating insulation housing part.

### CROSS-REFERENCE TO RELATED APPLICATIONS

This application claims priority to German Application No. 10 2019 211 101.7, filed Jul. 25, 2019, the contents of which are hereby incorporated herein in its entirety by reference.

### FIELD OF APPLICATION AND PRIOR ART

The invention relates to a radiant heating device and to a hob which is provided with at least one radiant heating device of this kind, preferably is provided with a plurality of radiant heating devices overall. In this case, at least one of the said radiant heating devices is a radiant heating device according to the invention.

U.S. Pat. No. 6,580,058 discloses a radiant heating device for a hob comprising a temperature pickup which is arranged in an enclosure ring between two concentric heating zones. Here, an elongate so-called bar-type controller which runs centrally over the heating zones is additionally provided.

### PROBLEM AND SOLUTION

The invention is based on the object of providing a radiant heating device of the kind mentioned at the outset for a hob and a hob of this kind comprising at least one radiant heating device of this kind, with which radiant heating device and hob problems of the prior art can be solved and it is possible, in particular, to operate a radiant heating device in a reliable manner and implement temperature detection thereon, preferably for safety reasons, as accurately and with as quick reactions as possible.

This object is achieved by a radiant heating device having the features of claim 1 and by a hob having the features of claim 23. Advantageous and preferred refinements of the invention are the subject matter of the further claims and will be explained in more detail below. In so doing, some of the features are described only for the radiant heating device or only for the hob. However, irrespective of this, they are intended to be able to apply both to the radiant heating device and to the hob on their own and independently of one another. The wording of the claims is incorporated in the description by express reference.

The radiant heating device has a sheet-like carrier which has or forms a carrier surface on its top side. At least one electrical or ohmic heating element which is arranged so as to run in a sheet-like manner on the carrier surface, for example as a narrow metal strip or coiled wire, wherein it can run in a spiral or meandering manner in particular, is provided. This is known for radiant heating devices of this kind for hobs. An outer edge on the carrier surrounds the carrier surface, wherein all heating elements of the radiant heating device are arranged within this outer edge. It is therefore advantageously the outermost surrounding border of the radiant heating device. A temperature sensor which is arranged higher than the carrier surface is provided, wherein it can be arranged directly above it or else next to it and above it. It is advantageously designed such that it can be electrically evaluated, that is to say has a temperature-dependent resistance value or another temperature-dependent electrical property. It is particularly advantageously not a thermomechanical pickup or sensor.

According to the invention, the temperature sensor is arranged within an outer side of the outer edge, that is to say within the outer edge or else therein itself. Therefore, it can also be an integral constituent part of the radiant heating device. The temperature sensor is the only temperature sensor or temperature pickup of the radiant heating device, that is to say no further mechanical or electronic temperature sensor or similar functional unit for temperature detection or limiting is provided on this radiant heating device. The temperature sensor is advantageously arranged above a region which is free of heating elements, this region preferably being a region of the carrier surface. Therefore, here, no heating elements run directly below the temperature sensor or a temperature sensor housing in which the temperature sensor is arranged, that is to say in the projection of the temperature sensor or temperature sensor housing. Therefore, excessive direct heating of the temperature sensor, which is advantageously intended to detect a temperature of a hob plate above it or a cooking vessel on this hob plate, can be avoided. However, this does not have to be the case. A temperature sensor housing of this kind covers the temperature sensor at the top and to the side and encloses the said temperature sensor in these directions. The temperature sensor housing is designed so as to be electrically insulating and thermally insulating at least at the top and to the side. It advantageously serves not only to accommodate the temperature sensor and for accurate arrangement of the said temperature sensor, but rather can also serve to protect it. This will be explained in more detail below.

Temperature detection can be improved and made more accurate by arranging the temperature sensor in the temperature sensor housing. Undesired influences can be reduced in this way. The design can be simplified at the same time once again by leaving out other temperature pickups or the like. When the temperature sensor is designed such that it can be electrically evaluated, a wide range of possibilities both for a safety function in respect of excessive temperatures and also in respect of possible convenience functions, which require precise temperature detection or temperature control, are produced. The temperature sensor housing advantageously covers the temperature sensor at the top and to the side and encloses the said temperature sensor in all directions. The temperature sensor housing is designed so as to be electrically insulating and thermally insulating at least at the top and to the side, wherein the said temperature sensor housing consists of an inner electrically insulating insulation housing part with the temperature sensor therein and an outer surrounding thermally insulating insulation housing part.

In an advantageous refinement of the invention, the temperature sensor is an NTC element or an NTC temperature sensor which can be easily evaluated in a known manner. As an alternative, the said temperature sensor can also be a PTC element. A temperature sensor of this kind can preferably have a linear characteristic. Therefore, the said temperature sensor can be evaluated particularly readily. Further possible options are a PT100, PT500 or another PT resistor or thermocouples.

An operating temperature of the temperature sensor can lie between 300° C. and 650° C., advantageously between 350° C. and 600° C. Therefore, the temperature sensor can lie in the expected region of the temperatures which can occur here on the bottom side of the hob plate where the temperature sensor is located.

The temperature sensor is advantageously arranged within the outer edge, that is to say not in the lateral direction next to or outside the said outer edge. The temperature sensor is particularly advantageously arranged above the carrier surface, that is to say higher than the said carrier surface and above it. The temperature sensor can also be arranged in the outer edge, but it is preferably arranged within the said outer edge.

It is further advantageous when the temperature sensor is arranged in the outer half or in the outer region of the carrier surface, that is to say not directly in the centre and not in a central region. The temperature sensor is particularly advantageously arranged at a point of between 80% and 60% of the shortest distance, which runs between the centre point of the carrier surface and the outer edge, away from the centre point. Therefore, the said temperature sensor can be arranged in the outer third or in the outer quarter.

In a refinement of the invention, the temperature sensor housing lies directly on the carrier surface. Therefore, the said temperature sensor housing can possibly be supported on the carrier surface or on the carrier. Separate holders or the like can be dispensed with. The said temperature sensor housing can equally also be fastened there, in particular is fastened in an interlocking manner or by adhesive bonding. As a result, accurate positioning both in relation to the radiant heating device and also in relation to a hob plate above it is also possible. As an alternative, fastening of the temperature sensor housing to the radiant heating device is possible by pushing in or insertion from the side or from the bottom. In this case, the temperature sensor housing can be of elongate design.

In an advantageous refinement of the invention, the temperature sensor housing, in particular an insulation housing part of the temperature sensor housing, can be of open design at the bottom in the direction of the carrier surface, either by way of a continuous cross section or by way of a constricted small opening. Electrical connections can be guided to the temperature sensor here, in particular when the temperature sensor housing rests directly on the carrier. In this case, the opening is also, as it were, closed again, specifically by the carrier or its carrier surface. Since no heating elements run beneath the temperature sensor housing, no undesired or harmful overheating or influencing of the temperature sensor, which would take place directly through the heating elements and therefore could create a very high temperature, can take place from the bottom either. This could mean excessive undesired influencing of the temperature sensor since the heating elements of a radiant heating device can reach temperatures of above 1100° C.

The temperature sensor housing can advantageously contain thermally insulating material and electrically insulating material. Therefore, the temperature sensor is protected against short circuits specifically by contact with the heating elements. Therefore, the temperature sensor can also be protected against excessive influencing or heating by the heating elements. The temperature sensor is intended to specifically firstly primarily detect the temperature on a hob plate composed of glass ceramic in order to protect said hob plate from excessive temperature, generally above 400° C., by way of the heating elements being entirely or partially switched off. This is a customary and known function of a radiant heating device. Secondly, a temperature of a cooking vessel which is placed on the hob plate can therefore be detected through the hob plate, primarily when the cooking vessel rests directly on the top side of the hob plate. This is advantageously highly probable specifically when the temperature sensor is arranged in this outer region of the radiant heating device or above the carrier surface. In this outer region, the cooking vessel highly probably rests on the top side of the hob plate, as is known. The temperature sensor is particularly advantageously surrounded to the side by thermally insulating material and electrically insulating material. Towards the top, only electrically insulating material is advantageously provided above the temperature sensor, so that the temperature of the hob plate and primarily a cooking vessel which is placed above it can be detected as effectively and quickly as possible, so that a temperature control arrangement can rapidly intervene. Therefore, a case in which a cooking vessel which has been placed down is not intended to exceed a specific temperature because, for example, food products arranged therein, in particular oil or fat, could catch fire can also be covered. This can happen at, for example, 350° C. to 385° C. If a temperature sensor can identify that this temperature has been reached on or in a cooking vessel, the radiant heating device can switch off. This is an advantageous function, in addition to monitoring the temperature of the hob plate.

The temperature sensor housing can advantageously contain an insulation housing part which consists of thermally insulating material or contains the said material. A phyllosilicate, in particular expanded phyllosilicate or vermiculite, can preferably be used for this purpose. Very good stable and solid components, in particular including housing parts, can also be produced from this. The thermal insulation is very good here.

The temperature sensor housing preferably has an insulation housing part which consists of electrically insulating material or contains the said material, preferably ceramic. The said ceramic can be a ceramic which is routinely used for temperature-resistant insulation purposes.

In view of the two abovementioned housing parts, provision can be made for the temperature sensor housing to contain the two said materials with the different purposes of thermal insulation and electrical insulation not as a mixed material or the like, but equally at least in two parts with at least two parts, each of which consists of one of the said materials. Respectively optimal division of the functions can be achieved in this way.

It is possible for the two housing parts, specifically firstly the insulation housing part and secondly the insulation housing part, to be designed and arranged at least partially as a double-layer material arrangement which at least partially forms the temperature sensor housing. This is advantageously done to the side, although the two materials can also be provided at the top, but preferably only the electrically insulating material is provided over the temperature sensor. The thermally insulating material of the insulation housing part can then be provided next to it or laterally surrounding it.

The temperature sensor housing advantageously has a low thermal capacity or thermal storage capability, in particular towards the temperature sensor. Ceramic is particularly well-suited to this. Therefore, the said temperature sensor can detect a temperature quickly and as directly as possible, preferably the hob plate which is located above it and a pot which is placed on the said hob plate towards the top. Thermal insulation to the side is preferably such that a temperature difference of 100° C. to 350° C. is produced at temperatures of the radiant heating elements or heating conductor strips of 1000° C. to 1150° C. since temperatures of 500° C. to 800° C. can be present on the outer side of the temperature sensor housing. The temperature sensor can advantageously be designed such that it can operate permanently at temperatures of 100° C. to 350° C.

In a refinement of the invention, the temperature sensor is arranged completely within the insulation housing part. At least 80% of the insulation housing part in turn can be arranged in the insulation housing part, preferably with the region in which the temperature sensor is arranged being arranged therein. The insulation housing part can be arranged at the top on the top side of the insulation housing part, preferably at the top on the top side or even in a manner protruding out of the top side. In this case, an excess length of the insulation housing part at the top beyond the insulation housing part can be between 0.1 mm and 3 mm. This small excess length can suffice so that the insulation housing part bears against the bottom side of the hob plate with good thermal coupling of the temperature sensor, but the insulation housing part does not.

The insulation housing part advantageously has an opening at the top, into which opening the insulation housing part is inserted, preferably from above. In this case, a surface region which protrudes laterally in a collar-like manner or encircling collar of the insulation housing part can rest on the top side of the insulation housing part or at the top on the insulation housing part. Therefore, holding with defined association is possible. The insulation housing part can be designed as a kind of upright sleeve with a wide collar or protruding upper cover. This or another opening can pass through the insulation housing part at the bottom for electrical connection of the temperature sensor from below since thermal insulation for the connection is possible here. The connection can preferably be made through the carrier and the carrier surface, that is to say entirely from below through the entire radiant heating device. Therefore, no connections have to be guided across the heating elements or close to the said heating elements.

In a refinement of the invention, the temperature sensor can be encapsulated or completely enclosed in the insulation housing part, preferably by means of epoxy resin, a ceramic potting compound or the like. In this case, the temperature sensor can be arranged in an air-tight manner in the insulation housing part, as a result of which it is very well protected against corrosion.

The insulation housing part can have a wall thickness of at most 3 mm, preferably at most 1.5 mm, in particular on a top side of the insulation housing part too, which top side is intended to bear against the bottom side of the hob plate or is intended to face the said bottom side. The said insulation housing part is therefore of relatively thin design, primarily considerably thinner than the insulation housing part. This suffices for electrical insulation, and a thermal conductivity is then high enough here for the temperature detection at the top explained above.

The insulation housing part can have a wall thickness of at most 30 mm, preferably at most 8 mm to 20 mm, wherein a maximum wall thickness of the insulation housing part is provided to the side in particular. Even a relatively uniform wall thickness can be provided here. The said insulation housing part is therefore of relatively thick design. A minimum wall thickness can be 4 mm, advantageously 6 mm. Therefore, thermal influencing directly by the heating elements is relatively severely reduced.

The temperature sensor housing can preferably be arranged high on the radiant heating device in such a way that it lies, by way of its top side or a topmost point, at the height of +/−0.5 mm to +/−2 mm of the highest plane of the radiant heating device or of the top side of the outer edge. This means that the top side of the said temperature sensor housing, which is thermally well coupled to the temperature sensor, is arranged relatively far up on the radiant heating device and therefore very close to the bottom side of the hob plate, precisely where the temperature is ultimately intended to be detected. If the top side of the temperature sensor housing lies slightly higher than the top side of the radiant heating device, it is ensured that said top side of the temperature sensor housing bears against the bottom side of the hob plate.

The radiant heating device is advantageously designed as a structural unit which can be individually handled. Therefore, the said radiant heating device can be constructed and operated, as it were, without further functional units such as external temperature sensors. A hob can then also have at least one radiant heating device of this kind and at least one conventional radiant heating device which still has, for example, an elongate thermomechanical temperature pickup or limiter. The hob according to the invention further has a hob plate against the bottom side of which the radiant heating device is pressed from below and in particular can bear against by way of a top side of its outer edge. The temperature sensor or the temperature sensor housing are at a distance of at most 2 mm from the bottom side of the hob plate. The said temperature sensor and the temperature sensor housing preferably bear against the bottom side of the hob plate for the abovementioned good thermal coupling

A hob can have a plurality of radiant heating devices, wherein at least one radiant heating device is not designed according to the invention as described above but rather has a temperature sensor or temperature pickup of different design. This is advantageously an abovementioned mechanical temperature pickup. Therefore, a hob can be populated in a mixed manner. Possible convenience and safety functions can then be achieved primarily on the one radiant heating device according to the invention.

These and further features are evident not only from the claims but also from the description and the drawings, where the individual features can each be implemented on their own or severally in the form of subcombinations for an embodiment of the invention and in different fields and can be advantageous and independent protectable embodiments for which protection is claimed here. The subdivision of the application into individual sections and subheadings does not limit the general validity of the statements made thereunder.

### BRIEF DESCRIPTION OF THE DRAWINGS

Further advantages and aspects of the invention can be found in the claims and the following description of preferred exemplary embodiments of the invention which are explained below with reference to the figures, in which:

FIG. 1 shows a sectional illustration through a hob according to the invention comprising a radiant heating device according to the invention having a temperature sensor in a temperature sensor housing,

FIG. 2 shows a temperature sensor housing in accordance with FIG. 1 in views from above, from the side and from the front,

FIG. 3 shows a plan view of the radiant heating device according to the invention similarly to FIG. 1,

FIG. 4 shows an oblique illustration of the radiant heating device from FIG. 3, and

FIG. 5 shows a plan view of a modified radiant heating device which is designed as a so-called two-circuit radiant heating device having a single temperature sensor.

### DETAILED DESCRIPTION OF THE EXEMPLARY EMBODIMENTS

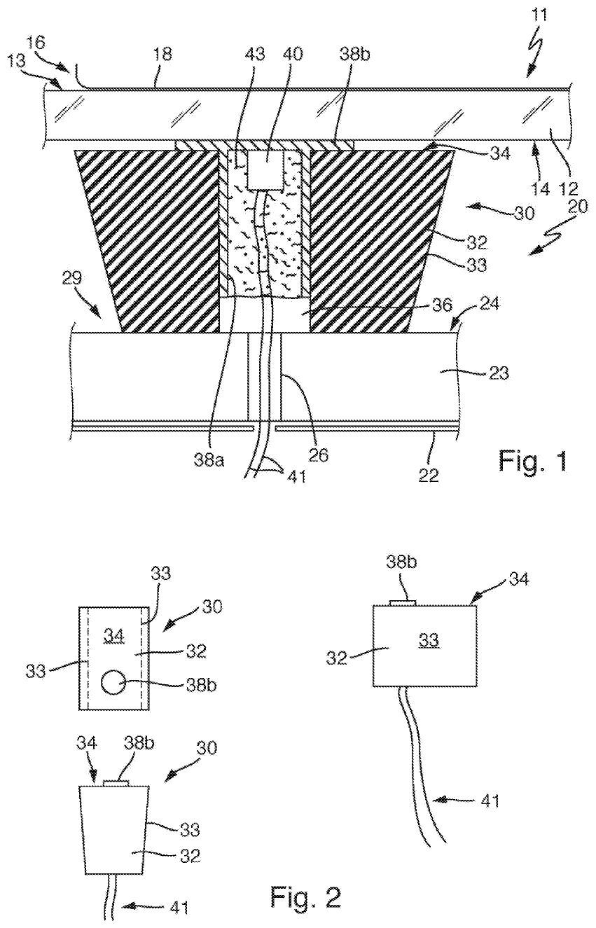

FIG. 1 shows a highly enlarged lateral sectional illustration of a hob 11 according to the invention. The hob 11 has a hob plate 12 which advantageously consists of glass ceramic as is customary. The hob plate 12 has a top side 13 and a bottom side 14. A cooking point 16 is formed on the top side 13. A pot 18 is placed on the said cooking point, a detail of the bottom of which pot is illustrated.

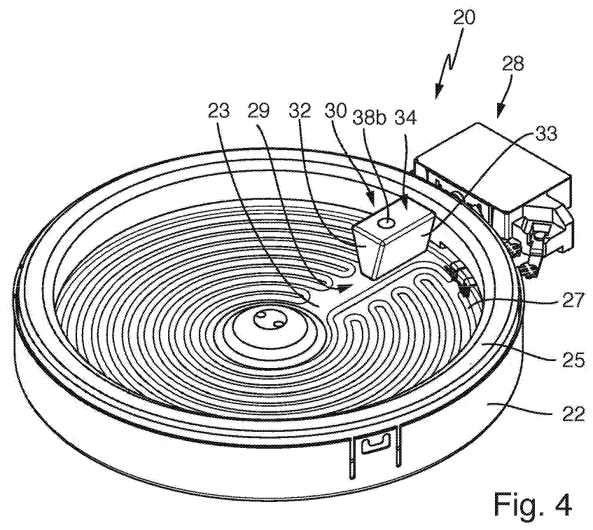

A radiant heating device 20 according to the invention, only a detail of which is illustrated here, is arranged below the hob plate 12. However, the said radiant heating device is designed substantially according to FIGS. 3 and 4. The radiant heating device 20 has a carrier tray 22 composed of sheet metal, as is customary, that is to say with a vertically raised encircling edge. A carrier 23 composed of special thermally insulating and high-temperature-resistant and stable material is laid into the carrier tray 22. Reference is made to U.S. Pat. No. 5,834,740 in this respect. The carrier 23 has a top side 24. An insulating edge 25, illustrated in FIGS. 3 and 4, which is placed onto the top side and, by way of its top side, can and should be pressed against the bottom side 14 of the hob plate 12 runs along an outer edge. The carrier 23 has a continuous bore 26 which also passes through the carrier tray 22. This will be explained in yet further detail below.

A temperature sensor housing 30 having a temperature sensor 40 arranged therein is placed, possibly adhesively bonded, onto the carrier 23 in a free region 29 in which no heating elements 27 run on the carrier 23. The said temperature sensor housing can have the abovementioned dimensions. The temperature sensor housing 30 is of two-part design. A first part, which forms the outer side, is formed by an insulation housing part 32, advantageously produced from expanded and pressed vermiculite. The said first part is highly temperature-resistant, and at the same time has very good thermal insulating properties. The insulation housing part 32 has, on the relatively long lateral side, two oblique sides 33, that is to say becomes narrower from top to bottom. A top side 34 of the insulation housing part 32 is largely flat. An opening 36, here advantageously designed as a round-cylindrical opening 36, passes through the insulation housing part 32. The said opening should be in alignment with the bore 26 in the carrier 23 in the fastened state.

An insulation housing part 38 is inserted into the said opening 36 from above. A lower insulation housing part 38a can be designed as a kind of short round pipe and consist of ceramic, advantageously a solid and highly temperature-stable ceramic. The insulation housing part 38a can be designed as a round-cylindrical pipe with a wall thickness of less than 1.5 mm, advantageously barely 1 mm. A further insulation housing part 38b is mounted on top. The said further insulation housing part is a round disc which is produced and connected in one piece with the insulation housing part 38a, as an alternative they can be adhesively bonded. Therefore, the upper disc-like insulation housing part 38b acts as a kind of flange. This flange or the insulation housing part 38b bears on the top side 34 of the insulation housing part 32. A wall thickness of the upper insulation housing part 38b also advantageously lies in the abovementioned region, so that the same wall thickness of both insulation housing parts is produced overall. The pipe-like insulation housing part 32a fits precisely into the opening 36 and may possibly be jammed therein to a certain extent in the process.

The temperature sensor 40, advantageously designed as an above-described NTC sensor, bears against the disc-like insulation housing part 38b, advantageously directly against the bottom side of the said insulation housing part, within the insulation housing part at the top. Therefore, good temperature transfer or heat transfer is ensured here. Furthermore, the temperature sensor 40 is potted or fastened by means of a potting compound 43 and defined in respect of its position. Therefore, the temperature sensor 40 is also protected mechanically and against corrosion. Furthermore, it is possible to ensure in this way that the said temperature sensor also actually bears permanently against the bottom side of the upper insulation housing part 38b for heat transfer which is as good and direct as possible.

By way of being placed against the bottom side of the upper insulation housing part 38b and on account of its low wall thickness, the temperature sensor 40 can detect a temperature above it, that is to say on the insulation housing part 38b, relatively accurately and primarily very quickly. The said temperature can be the temperature of the hob plate 12 in the region above the said temperature sensor. On account of the relatively poor thermal conductivity of glass ceramic, in particular poor lateral thermal conductivity, temperature influences of the heating elements 27 of the radiant heating device 20 are low or negligible. Similarly, influencing of the temperature of the hob plate 12 directly above the temperature sensor 40 is only very low, a temperature detection through the hob plate 12, which is a few millimetres thick, at the top, that is to say in the direction of the pot 18 or its bottom, is more direct and predominant. Therefore, the temperature sensor 40 can very readily identify the temperature of a pot 18 which is placed above the said temperature sensor on the cooking point 16 which is formed by the radiant heating device 20. Owing to the thermal insulation of the relatively thick insulation housing part 32, an influence of the heating elements 27 arranged laterally beneath the said insulation housing part is relatively minor. The temperature sensor 40 therefore measures, in simple terms, a temperature of the hob plate 12 and a pot 18 which is placed above it much more strongly or predominantly than that of the heating elements 27 themselves.

Owing to the relatively complicated two-part or two-piece refinement of the temperature sensor housing 30 composed of the two different materials, very good thermal insulation of the temperature sensor can be achieved to the side, the material vermiculite or phyllosilicate being very well suited to this. Owing to the arrangement of the temperature sensor itself in the thin insulation housing part composed of relatively good thermally insulating ceramic, heat transfer at the top, that is to say in the direction of the hob plate, can be very good.

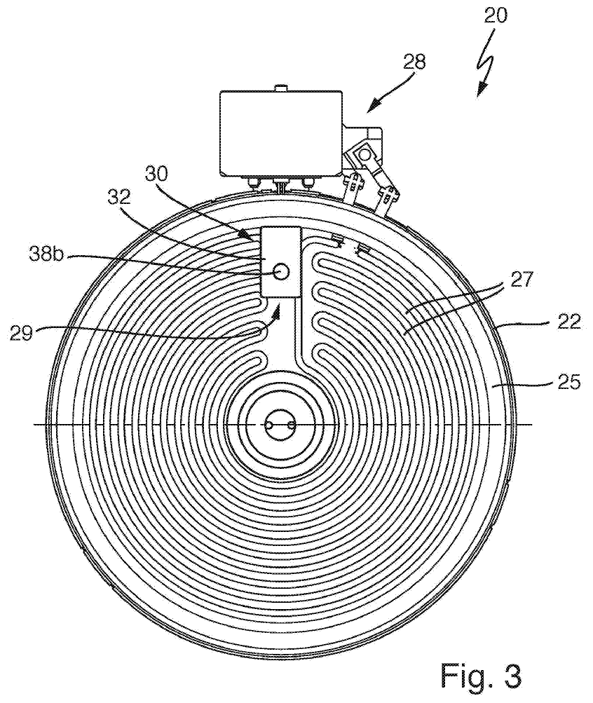

The various views of the temperature sensor housing 30 in accordance with FIG. 2 show that the oblique sides 33 are provided only on the relatively long lateral sides. The said oblique sides are intended to allow the temperature sensor housing 30 to also be placed in a relatively narrow free region 29 in accordance with FIGS. 3 and 4, without a free region 29 of this kind having to be made bigger. This means, specifically, considerable tool costs and expenditure on conversion. However, in FIGS. 3 and 4, the heating elements 27 come very close to the temperature sensor housing 30 and almost touch it. Although the upper region projects beyond the nearest heating elements 27 on account of the oblique position of the oblique sides, the temperature sensor 40 contained therein and positioned centrally therebetween does not. The connection wires 41 of the temperature sensor 40 protrude out of the temperature sensor housing 30 at the bottom. The said connection wires are guided through the bore 26 in the carrier 23 and a corresponding opening therebeneath in the carrier tray 22 and are connected to a controller, not illustrated, of the hob 11, which controller can evaluate the temperature sensor 40.

It can be seen in FIG. 1 that the upper insulation housing part 38b rests fully on the top side 34 of the insulation housing part 32. Here, a corresponding recess could also be arranged in this top side 34, so that the upper insulation housing part 38b can be arranged in a manner at least partially recessed into this top side 34. However, it should be ensured that the top side of the insulation housing part 38b bears against the bottom side 14 of the hob plate 12 and projects beyond the top side of the insulation housing part 32.

A manner of laying the heating elements 27 which is known per se can be seen in the illustrations of FIGS. 3 and 4 of a radiant heating device 20 according to the invention. The said heating elements are electrically connected to a connection part 28. A free region 29 extends on the inside from this connection part 28 to a central region of the carrier 23. Here, elongate thermomechanical temperature pickups, so-called bar-type controllers, can also run as far as this central region. However, in the exemplary embodiment illustrated here, a bar-type controller of this kind is dispensed with, the temperature sensor 40 in the temperature sensor housing 30 is the only one in the entire radiant heating device 20. The said temperature sensor performs all the functions of the said elongate thermomechanical temperature pickup. Neither mechanical temperature sensors nor temperature sensors which can be electrically or electronically evaluated are additionally present here in the radiant heating device 20 according to the invention. This reduces the expenditure on evaluation and the material costs and assembly costs.

FIG. 3 shows that the temperature sensor 40 which is arranged below the upper insulation housing part 38b is arranged relatively far outside on or above a carrier surface of the carrier 23, that is to say close to the insulating edge 25. With respect to the outermost turn of the heating element 27, this is approximately 75% of the distance between the centre point of the carrier 23 and the inner side of the insulating edge 25. In this outer region, it can be assumed that a cooking vessel or a pot 18 which is placed down rests directly on the top side 13 of the hob plate 12. Owing to the said cooking vessel or pot resting directly on the hob plate 12 composed of glass ceramic, the temperature sensor 40 can detect the temperature of the said pot 18 through the upper insulation housing part 38b and through the hob plate 12 by means of contact heat.

If the temperature of the pot 18 increases to a great extent or reaches a temperature of above 350° C. or close to 385° C., starting from which intense development of smoke can occur when oil is heated or the oil can also catch fire, the temperature sensor 40 or the connected controller should identify this critical temperature, possibly using correction values or compensation values. The controller should then reduce the heating power of the radiant heating device 20, possibly even switch off the said radiant heating device.

It can be seen in the oblique illustration of FIG. 4 how, on account of the temperature sensor 30 being of narrower design towards the bottom on account of the oblique sides 33, the one heating element can run past the connection part 28 very close to it. Therefore, although it may run below the projection of the top side 34 of the insulation housing part 32, it is still not below the temperature sensor 40 itself, as is shown looking at FIG. 3 together with FIG. 1.

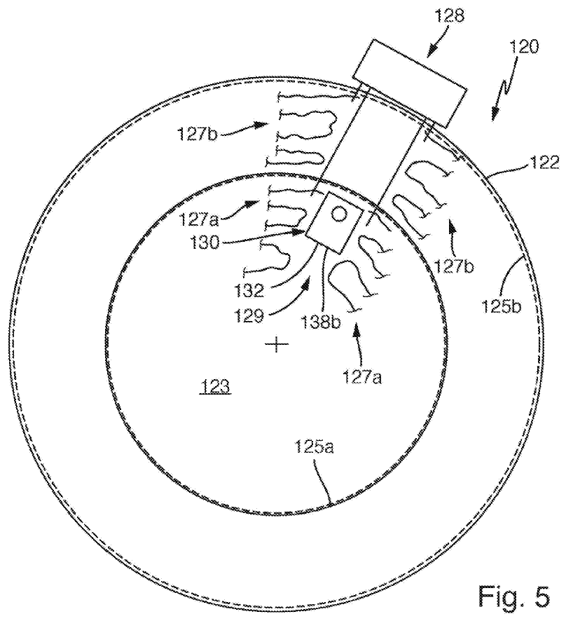

FIG. 5 shows a modification of the invention with a radiant heating device 120 which is designed as a so-called two-circuit heater. An inner round region has inner heating elements 127a which can be laid in a pattern in accordance with FIG. 3, as is indicated. Heating elements 127b are laid so as to run in a flat manner, specifically once again in a meandering manner, in an outer heating circuit which surrounds the inner heating circuit in an annular manner. The heating elements 127a and 127b are all connected to the connection part 128 or guided on the said connection part. From there, connection is made with an electrical power supply, for example via relays. The switching is performed by the controller.

This radiant heating device 120 also has a single temperature sensor, specifically integrated into the temperature sensor housing 130 in accordance with the refinement of FIGS. 1 to 4. This temperature sensor housing 130 also has an insulation housing part 132 with an opening from the top. An insulation housing part is inserted into the said insulation housing part, the upper disc-like insulation housing part 138b, in which the temperature sensor is arranged in a potted manner in turn, is illustrated. The electrical connection of the said insulation housing part is advantageously at the bottom through the carrier 123 and through the carrier tray 122, as described above.

In comparison to the arrangement of the temperature sensor in FIG. 3, it can be seen that the temperature sensor sits radially further to the outside here in FIG. 5 than in FIG. 3, and this can be identified on the insulation housing part 138b. The said temperature sensor sits, as it were, just in front of the inner insulating edge 125a. Therefore, the said temperature sensor lies at most close to the edge region of the outer second heating circuit with the heating elements 127b.

If a small pot corresponding to the inner heating circuit is placed onto the associated cooking point, the size of which corresponds to the inner insulating edge 125a illustrated in dashed lines for example, the said pot can be heated by the heating elements 127a. These form a free region 129 in which the temperature sensor housing 130 is mounted. It can be clearly seen here that the free region is wider than in FIG. 3, that is to say the distance from the temperature sensor housing 130 is greater.

Here, the temperature sensor is arranged at approximately 90% of the distance between the centre point of the carrier 123 and the inner insulating edge 125a. Therefore, a small pot will rest on the top side of a hob plate with the resulting very advantageous direct and rapid temperature measurement as explained above in this case too.

If a large pot corresponding to the size of the profile of the outer insulating edge 125b illustrated in dashed lines is placed onto the cooking point of the radiant heating device 120, it presumably also lies fully on the top side of the hob plate in the radially outer region. This then also still applies for that region of the pot which is located above the temperature sensor, so that the said temperature sensor can once again precisely and rapidly detect the pot temperature.

Therefore, a heating device 120 of this kind, corresponding to FIG. 5, can also be provided as a so-called two-circuit heating device with a single temperature sensor according to the invention, and further temperature sensors or temperature pickups are not required. Owing to the possible precise evaluation of the temperature sensor, an excessively high temperature of the hob plate, usually consisting of glass ceramic, can be identified and as a result even avoided. A dangerous temperature of this kind lies at 600° C. to 650° C. Furthermore, a temperature of a pot which is placed above the said temperature sensor can be detected very rapidly, so that the said pot also does not become hotter than intended or allowed.

1. Radiant heating device having:
a sheet-like carrier, said sheet-like carrier having a top side with a carrier surface on said top side, and having an outer edge,
at least one electrical heating element, said electrical heating element being arranged so as to run on said carrier surface,
said outer edge surrounding said carrier surface, wherein all of said electrical heating elements are arranged within said outer edge,
a temperature sensor, said temperature sensor being arranged higher than said carrier surface,
wherein:
said outer edge has an outer side,
said temperature sensor is arranged within said outer side of said outer edge,
said temperature sensor is the only temperature sensor of said radiant heating device,
said radiant heating device has a temperature sensor housing, said temperature sensor being arranged in said temperature sensor housing,
said temperature sensor housing covers said temperature sensor at a top and to a side and encloses said temperature sensor in said directions,
said temperature sensor housing is designed so as to be electrically insulating and thermally insulating at least at said top and to said side.

2. Radiant heating device according to claim 1, wherein said temperature sensor is an NTC element.

3. Radiant heating device according to claim 1, wherein an operating temperature of said temperature sensor lies between 300° C. and 650° C.

4. Radiant heating device according to claim 1, wherein said temperature sensor is arranged within said outer edge and above said carrier surface.

5. Radiant heating device according to claim 4, wherein said temperature sensor is arranged in an outer region of said carrier surface.

6. Radiant heating device according to claim 5, wherein said temperature sensor is arranged at a point of between 80% and 60% of the shortest distance between a centre point of said carrier surface and said outer edge at a distance from said centre point.

7. Radiant heating device according to claim 1, wherein said temperature sensor housing lies directly on said carrier surface and is fastened in an interlocking manner or by adhesive bonding.

8. Radiant heating device according to claim 1, wherein said temperature sensor housing is open at a bottom in a direction to said carrier surface.

9. Radiant heating device according to claim 1, wherein said temperature sensor housing has a thermally insulating insulation housing part, said thermally insulating insulation housing part consisting of thermally insulating material.

10. Radiant heating device according to claim 1, wherein said temperature sensor housing has an electrically insulating insulation housing part, said electrically insulating insulation housing part consisting of electrically insulating material.

11. Radiant heating device according to claim 9, wherein the said thermally insulating insulation housing part and said electrically insulating insulation housing part are designed and arranged at least partially as a double-layer material arrangement and at least partially form said temperature sensor housing.

12. Radiant heating device according to claim 11, wherein said temperature sensor is arranged completely within said electrically insulating insulation housing part, and at least 80% of said electrically insulation housing part is arranged in the thermally insulating insulation housing part.

13. Radiant heating device according to claim 12, wherein said electrically insulating insulation housing part is arranged on a top side of said thermally insulating insulation housing part.

14. Radiant heating device according to claim 13, wherein said electrically insulating insulation housing part is arranged on said top side of said thermally insulating insulation housing part or in a manner protruding out of said top side with an excess length over said top side beyond said thermally insulating insulation housing part of between 0.1 mm and 3 mm.

15. Radiant heating device according to claim 11, wherein said thermally insulating insulation housing part has an opening at a top side, and said electrically insulating insulation housing part is inserted into said opening by way of a surface region protruding laterally in a collar-like manner and resting on said top side of said thermally insulating insulation housing part.

16. Radiant heating device according to claim 15, wherein said opening passes through said thermally insulating insulation housing part to a bottom of said thermally insulating insulation housing part for electrical connection of said temperature sensor from below.

17. Radiant heating device according to claim 16, wherein said electrical connection of said temperature sensor passes through said carrier and said carrier surface.

18. Radiant heating device according to claim 10, wherein said temperature sensor is encapsulated or completely enclosed in said electrically insulating insulation housing part.

19. Radiant heating device according to claim 10, wherein said electrically insulating insulation housing part has a wall thickness of at most 3 mm.

20. Radiant heating device according to claim 9, wherein said thermally insulating insulation housing part has a wall thickness of at most 10 mm, wherein a maximum thickness of said wall of said thermally insulating insulation housing part is provided to a lateral side.

21. Radiant heating device according to claim 1, wherein said temperature sensor housing is arranged high on said radiant heating device in such a way that it lies, by way of said top side, at a height of +/−0.5 mm to +/−2 mm of a highest plane of said radiant heating device or of said top side of said outer edge.

22. Hob comprising at least one radiant heating device according to claim 1, wherein said hob has a hob plate with a bottom side, wherein said radiant heating device is pressed against said bottom side from below, wherein said temperature sensor or a temperature sensor housing are at a distance of at most 2 mm from said bottom side of said hob plate.

23. Hob according to claim 22, wherein it has a plurality of said radiant heating devices, wherein at least one said radiant heating device is not designed according to claim 1, but has a temperature sensor of different design than said temperature sensor of said radiant heating device according to claim 1.
